(19) United States
(12) Patent Application Publication
(10) Pub. No.: US 2008/0244916 A1
(43) Pub. Date: Oct. 9, 2008

(54) Hand-Held Power Tool with a Rod-Shaoed Grip

(76) Inventor: Sacha Felder, Langendorf SO (CH)

Correspondence Address: Striker, Striker & Stenby, 103 East Neck Road, Huntington, NY, 11743, US

(21) Appl. No.: 10/574,681

(22) PCT Filed: Nov. 4, 2005
(86) PCT No.: PCT/EP05/55747

§ 371 Date: Apr. 4, 2006

(30) Foreign Application Priority Data
Dec. 29, 2004 (DE) 10 2004 063 174.3

(51) Int. Cl. B27B 19/00; B27B 21/00

(52) U.S. Cl. 30/392; 30/519

(57) ABSTRACT

A hand-held power tool, in particular a barrel jigsaw, having a barrel grip (10).

The hand-held power tool has a detachable top handle (12) and a fastening device (14) for attaching the top handle (12).

### PRIOR ART

The invention is based on a hand-held power tool with a barrel grip according to the preamble of claim 1.

A hand-held power tool with a barrel grip embodied in the form of a barrel jigsaw is already known. The barrel jigsaw has an L-shaped housing with a shorter leg extending essentially parallel to a reciprocating motion of a saw blade and a longer leg extending perpendicular to the shorter leg, in the working direction. The longer leg constituting the barrel grip is essentially rod-shaped, with a round cross-sectional area, and encloses an electric motor. The barrel grip has a diameter designed to permit an average-sized user from a preselected target group to grasp the barrel grip at least to a large extent with one hand and to advantageously be able to guide the barrel jigsaw by means of the barrel grip.

The shorter leg of the housing extends away from a free end of the saw blade and is embodied in the form of a grasping knob at its free end.

### ADVANTAGES OF THE INVENTION

The invention is based on a hand-held power tool, in particular, a barrel grip jigsaw.

According to the invention, the hand-held power tool is provided with a removable top handle and a fastening device for attaching the top handle, in particular to at least one housing of the hand-held power tool. In this connection, the term “removable top handle” is understood in particular to mean a handle that extends at least partially along a housing and which is in particular provided so that it can be removed from a housing of the hand-held power tool. The term “provided” is understood in particular to mean “equipped” and/or “designed”. The term “barrel grip” is in particular understood to mean a grip that is advantageously aligned in the working direction and preferably at least partially encloses a drive unit of the hand-held power tool and which, in particular, is preferably provided for a user of average size to be able to grasp at least most of the way around, i.e. to grasp around more than 50% of it.

The embodiment according to the invention permits the hand-held power tool to be adapted in a particularly flexible fashion to different requirements and makes it possible to increase the convenience of the hand-held power tool.

The top handle can be attached to a housing of the hand-held power tool by means of various fastening devices deemed useful to those skilled in the art, in particular frictionally engaging and/or form-locking ones, but it is particularly advantageous for this attachment to be produced by a fastening device provided for tool-less attachment and detachment of the top handle to and from a housing of the hand-held power tool. This permits a particularly quick and convenient adaptation of the hand-held power tool.

In addition, the convenience can be increased if an on-off switch of the hand-held power tool is at least partially integrated into the top handle and in particular if the top handle is provided with a locking mechanism for locking the on-off switch, in particular for locking it in the on position.

In another embodiment of a hand-held power tool with a handle and an on-off switch at least partially integrated into the handle and in particular with a locking mechanism for locking the on-off switch, the locking mechanism has at least two at least largely decoupled actuating elements. In this context, the term “decoupled actuating elements” is understood to mean elements to be actuated in particular directly by a user, such as control buttons, rocker buttons, sliders, etc., that are comprised of separate components and/or are at least largely decoupled with regard to their freedom of movement so that in particular, one actuating element can be moved without causing the other actuating element to move.

The embodiment according to the invention can, through structurally simple means, achieve an advantageous, at least largely symmetrical design of the hand-held power tool, with either a locking or a non-locking on-off switch, and can, at least to a large degree, fulfill the same requirements for both left-handers and right-handers.

If the actuating elements are situated on opposite sides of the top handle, then they can be conveniently embodied for both left-handers and right-handers and can in particular be situated in conveniently accessible regions.

If the fastening device is at least in part integrally joined to a functional component of the on-off switch at least partially integrated into the top handle and/or if the on-off switch at least partially integrated into the top handle is at least in part integrally joined to an on-off switch at least partially integrated into the barrel grip, then this achieves savings with regard to additional components, assembly complexity, space, weight, and cost.

If a holding mechanism of the fastening device is integrally joined to an actuator rod guide, then only a few components are required to achieve a particularly advantageous guidance of an actuator rod and a jamming of the actuator rod can be prevented in a structurally simple manner, particularly in a transition region from the top handle into the barrel grip and particularly if the holding mechanism is comprised of a locking pin. In a particularly advantageous embodiment, the locking pin is hollow and the actuator rod is guided inside the locking pin.

In an additional embodiment of the invention, the top handle is provided to constitute a support surface for the back of a hand, i.e. constitutes a specially adapted open reach-through region between the housing and the top handle and/or has a specially embodied form so that when guiding the hand-held power tool by means of the barrel grip, the back of the user's hand is or can be additionally supported against the top handle. A corresponding embodiment can achieve a convenient operation of the hand-held power tool with a low exertion of holding force and with a particularly reliable connection between the user and the hand-held power tool.

In order to reliably provide various users with an advantageous distance between the top handle and the housing and to provide an advantageous, open reach-through region between the top handle and the housing, the open reach-through region can be embodied as adjustable, for example in that the position of the top handle is adjustable and/or supported so that it can move and/or in that additional components are provided to be attached to the top handle and/or to the housing.

If the support surface is comprised of a soft elastic component, e.g. in particular a component made of rubber or a rubber-like material, then an open reach-through region can be achieved that automatically adapts to a user and an elastic clamping force of the component can further increase the reliability of the connection between the user and the hand-held power tool.

The embodiment according to the invention can be used in various hand-held power tools deemed appropriate by those skilled in the art, e.g. in angle grinders, scrapers, hedge trimmers, planers, etc., but can be used to particular advantage in barrel jigsaws, in which, depending on the intended use, different possible holding attitudes are particularly advantageous. For example, when working on a hip high, horizontally aligned tabletop from above and watching the cutting progress from above, it is preferable to guide a barrel jigsaw by means of its top handle, whereas when working on a hip high, horizontally aligned tabletop from below and watching the cutting progress from above, it is preferable to guide a barrel jigsaw by means of a barrel grip. The top handle here is preferably adapted to an L-shaped housing design, which permits the embodiment according to the invention to be used with little adaptation cost, particularly in saws and planers.

### DRAWINGS

Other advantages ensue from the following description of the drawings. An exemplary embodiment of the invention is shown in the drawings. The drawings, specification, and claims contain numerous defining characteristics in combination. Those skilled in the art will also suitably consider the defining characteristics individually and unite them in other meaningful combinations.

FIG. 1 is a side view of a hand-held power tool according to the invention, embodied in the form of barrel jigsaw,

FIG. 2 shows the hand-held power tool from FIG. 1, just before installation of a top handle,

FIG. 3 shows the hand-held power tool, right during installation of the top handle,

FIG. 4 shows the top handle from above,

FIG. 5 shows a detail of a longitudinal section through the hand-held power tool from FIG. 1, with the top handle installed,

FIG. 6 shows an enlarged detail labeled VI in FIG. 5, and

FIG. 7 shows an enlarged detail of the top handle, labeled VII in FIG. 5.

### DESCRIPTION OF THE EXEMPLARY EMBODIMENT

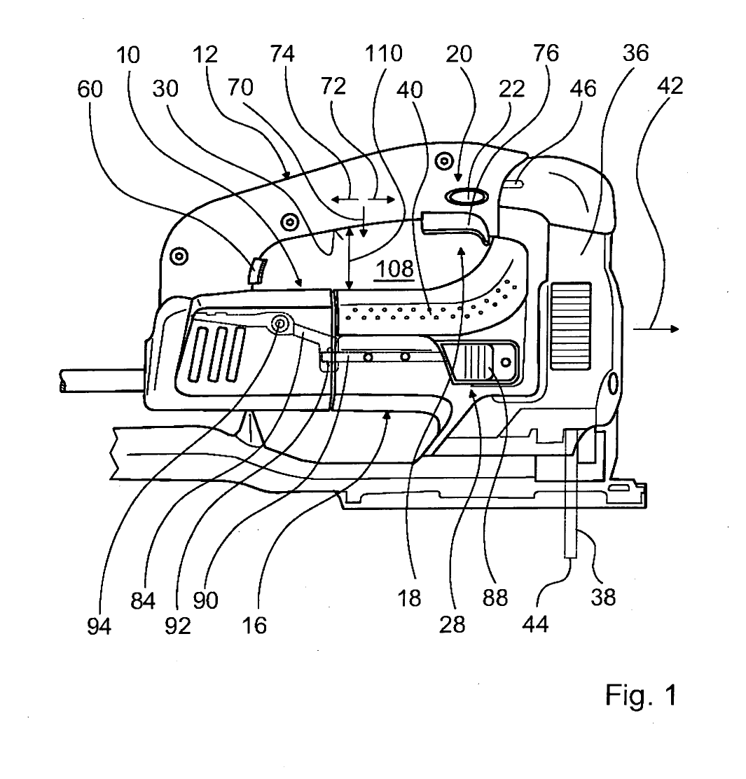

FIG. 1 shows a hand-held power tool according to the invention, embodied in the form of a barrel jigsaw, with a barrel grip 10. The hand-held power tool has an essentially L-shaped housing 16, a shorter leg 36 extending essentially parallel to a reciprocating motion of a saw blade 38 and a longer leg 40 extending perpendicular to the shorter leg 36, parallel to a working direction 42. The longer leg 40 constituting the barrel grip 10 is essentially rod-shaped, with a round cross-sectional area, and encloses an electric motor, not shown in detail. The barrel grip 10 has a diameter designed to permit an average-sized user to grasp at least most of the way around the barrel grip 10 with one hand and to advantageously be able to guide the hand-held power tool by means of the barrel grip 10.

The shorter leg 36 of the housing 16 extends in the direction away from a free end 44 of the saw blade and is embodied in the form of a grasping knob at its free end.

In addition to the barrel grip 10, the hand-held power tool has a removable top handle 12 and a fastening device 14 for attaching the top handle 12 to the housing 16 (FIGS. 1 through 7). The top handle 12 extends from a free end of the longer leg 40, i.e. the barrel grip 10, to a free end of the shorter leg 36, is embodied in the form of an arc, and has an oval cross-sectional area and contact surfaces adapted to the form of the housing 16 at the free ends of the legs 36, 40.

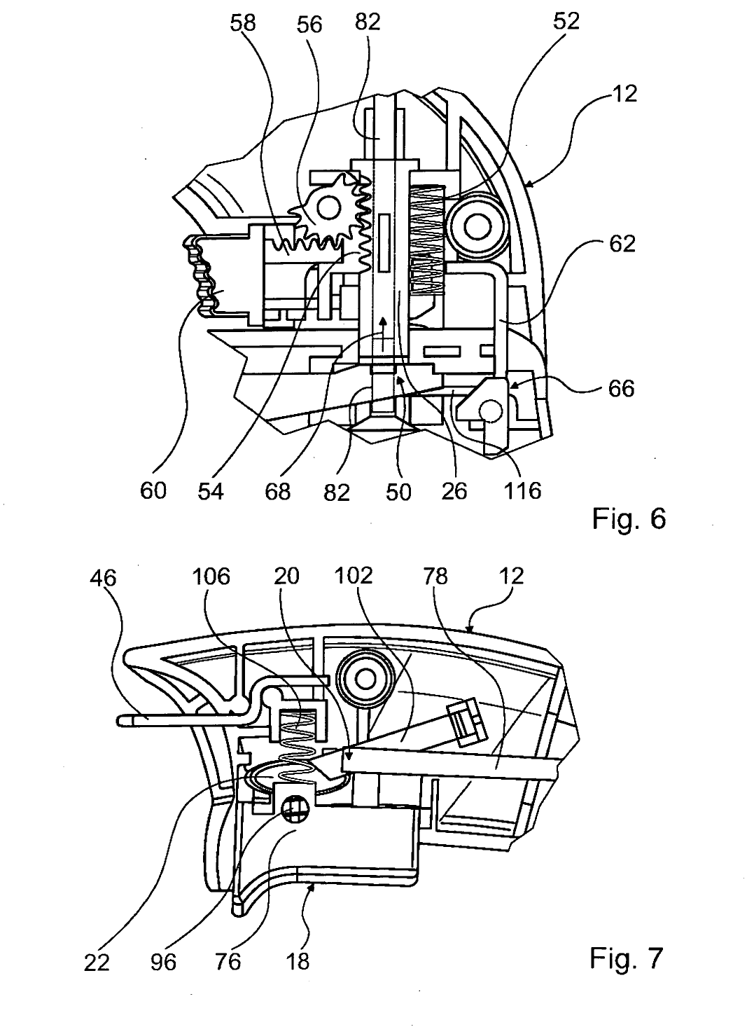

The fastening device 14 is provided for tool-free attachment and detachment of the top handle 12 to and from the housing 16. The fastening device 14 has a fixed metal tab 46 at a first end of the top handle 12, provided for attachment to the shorter leg 36 of the housing 16, and has a slot-shaped recess 48 situated in the housing 16 at the free end of the shorter leg 36 and correspondingly adapted to the metal tab 46 (FIGS. 6 and 7). In addition, the fastening device 14, at a second end of the top handle 12 provided for attachment to the longer leg 40, has a detent mechanism 50 with a locking pin 26 supported so that it can move in opposition to a helical compression spring 52 (FIGS. 5 and 6). The locking pin 26 is coupled via a set of teeth 54, which are formed onto it, and a gear 56 to a toothed rod 58 formed onto an actuating button 60. A U-shaped retaining tab 62 of the fastening device 14 is attached to the second end of the top handle 12. To cooperate with the locking pin 26, an opening 64 is let into the top side of the barrel grip 10 in the end region of its longer leg 40. To cooperate with the U-shaped retaining tab 62, the free end of the longer leg 40, i.e. of the barrel grip 10, has a receiving region 66 into which one leg 116 of the U-shaped retaining tab 62 can be guided under a rib, not shown in detail, of the housing 16. The receiving region 66 is covered by means of a pivotable closing flap 114, which pivots into its open position upon insertion of the leg 116 of the U-shaped retaining tab 62.

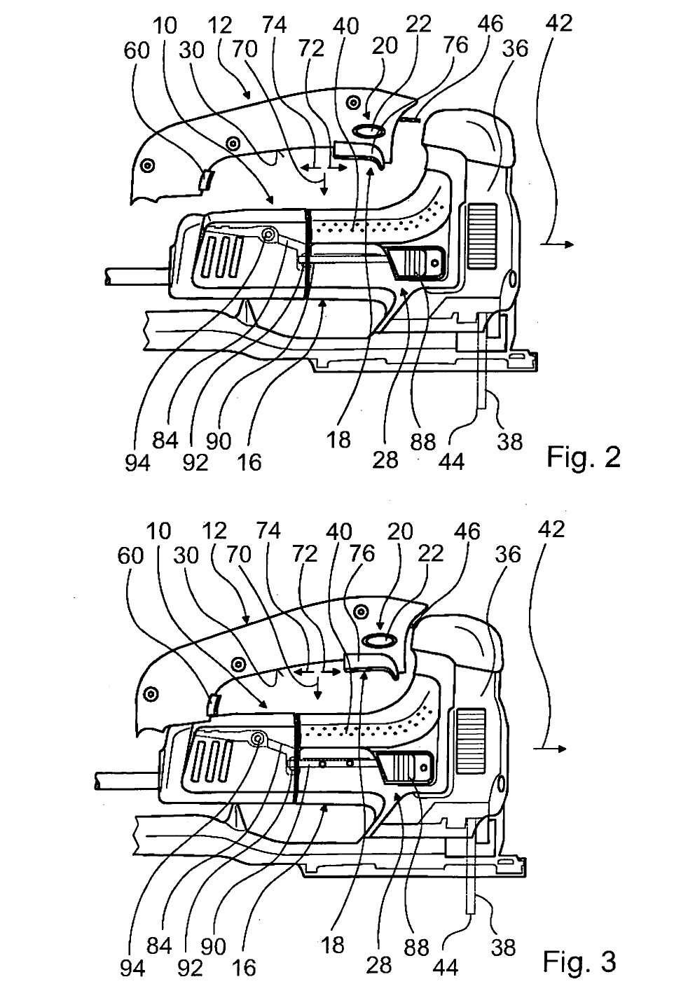

To install the top handle 12, first, the metal tab 46 pointing in the working direction 42 is inserted into the recess 48 of the shorter leg 36 (FIGS. 2 and 3). Then, while exerting a force in the direction 70 toward the barrel grip 10, the top handle 12 is slid in the direction 72 of the shorter leg 36. In the course of this, the leg 116 of the U-shaped retaining tab 62 is guided into the receiving region 66, under the rib of the housing 16 and the locking pin 26 comes into contact with the longer leg 40, i.e. the barrel grip 10, and is deflected in a direction 68 oriented away from the longer leg 40, counter to a spring force of the helical compression spring 52. With a continued movement of the top handle 12 in the direction 72, the locking pin 26 is moved into a position over the opening 64 in the longer leg 40, i.e. the barrel grip 10, and, driven by the helical compression spring 52, engages in detent fashion in the opening 64, thus affixing the top handle 12 to the housing 16 in a definite position. In the mounted state, the top handle 12 encompasses part of the free end of the shorter leg 36 and part of the free end of the longer leg 40.

To detach the top handle 12, the actuating button 60 is pressed and the locking pin 26 is moved in the direction 68 oriented away from the barrel grip 10 (FIGS. 5 and 6). Then, the top handle 12 can be withdrawn in a direction 74 oriented away from the shorter leg 36 (FIGS. 2 and 3).

Part of an on-off switch 18 is integrated into the top handle 12, namely an actuating button 76 supported in mobile fashion at the end of the top handle 12 oriented toward the shorter leg 36 (FIGS. 5 and 6). The actuating button 76 is coupled to an end of a rocker switch 78 of the on-off switch 18, which rocker switch 78 extends in the longitudinal direction through the top handle 12 and is supported in pivoting fashion at a bearing point 80 situated approximately in the middle of the top handle 12 in its longitudinal direction. A second end of the rocker switch 78 is coupled to an actuator rod 82 of the on-off switch 18. The locking pin 26 of the fastening device 14 has an actuator rod guide integrated into it; the actuator rod 82 is in fact guided inside the hollow, tubular locking pin 26.

With the top handle 12 installed, if a user pushes the actuating button 76, then the end of the rocker switch 78 oriented toward the actuating button 76 is deflected away from the barrel grip 10 and its end oriented away from the actuating button 76 is deflected toward the barrel grip 10. The actuator rod 82 is slid through the locking pin 26 and, via a pivoting flap 112, acts on an electrical switch 86. The pivoting flap 112 is supported on a rocker switch 84 of an on-off switch 28 integrated into the barrel grip 10 and can pivot around a bearing axis oriented in the longitudinal direction of the barrel grip 10. With the top handle 12 installed, the rocker switch 84 itself is locked in position by the leg 116 of the U-shaped retaining tab 62 that is inserted into the receiving region 66, preventing an activation and/or deactivation of the hand-held power tool by an actuation slider 88 situated on the barrel grip 10. When the top handle 12 is not installed, the flap 112 prevents an open passage from an outside region from extending into the region of the electrical switch 86 and thus prevents the penetration of dirt.

Both the on-off switch 18 partially integrated into the top handle 12 and the on-off switch 28 integrated into the barrel grip 10 are embodied as integrally joined to the electrical switch 86 so that both the on-off switch 18 of the top handle 12 and the on-off switch 28 of the barrel grip 10 can be used to activate and deactivate the hand-held power tool by means of the electrical switch 86.

On an end of the barrel grip 10 oriented toward the shorter leg 36, the on-off switch 28 integrated into the barrel grip 10 has the actuating slider 88, which is coupled to a connecting rod 90 that extends in the longitudinal direction inside the barrel grip 10 and is supported so that it can moved in this longitudinal direction (FIG. 1). The end of the connecting rod 90 oriented away from the actuating slider 88 is coupled to the rocker switch 84, and a bolt, not shown in detail, fastened to the connecting rod 90 reaches through an oblong hole 92 in the rocker switch 84. The rocker switch 84 is supported in pivoting fashion at a bearing point 94 situated between the electrical switch 86 and the coupling point with the connecting rod 90 in the longitudinal direction of the barrel grip 10 (FIGS. 1, 5, and 6).

If a user moves the actuating slider 88 toward the shorter leg 36 of the housing 16, then the end of the rocker switch 84 oriented toward the connecting rod 90 is deflected toward a top side of the barrel grip 10 and its end oriented away from the connecting rod 90 is deflected away from the top side of the barrel grip 10, thus acting on the electrical switch 86. When the top handle 12 is not installed and the hand-held power tool is deactivated, the rocker switch 84 and the flap 112 supported on the rocker switch 84 close the opening 64, which is provided to permit the actuator rod 82 of the on-off switch 18 of the top handle 12 to pass through it in order to actuate the electrical switch 86 when the top handle 12 is installed.

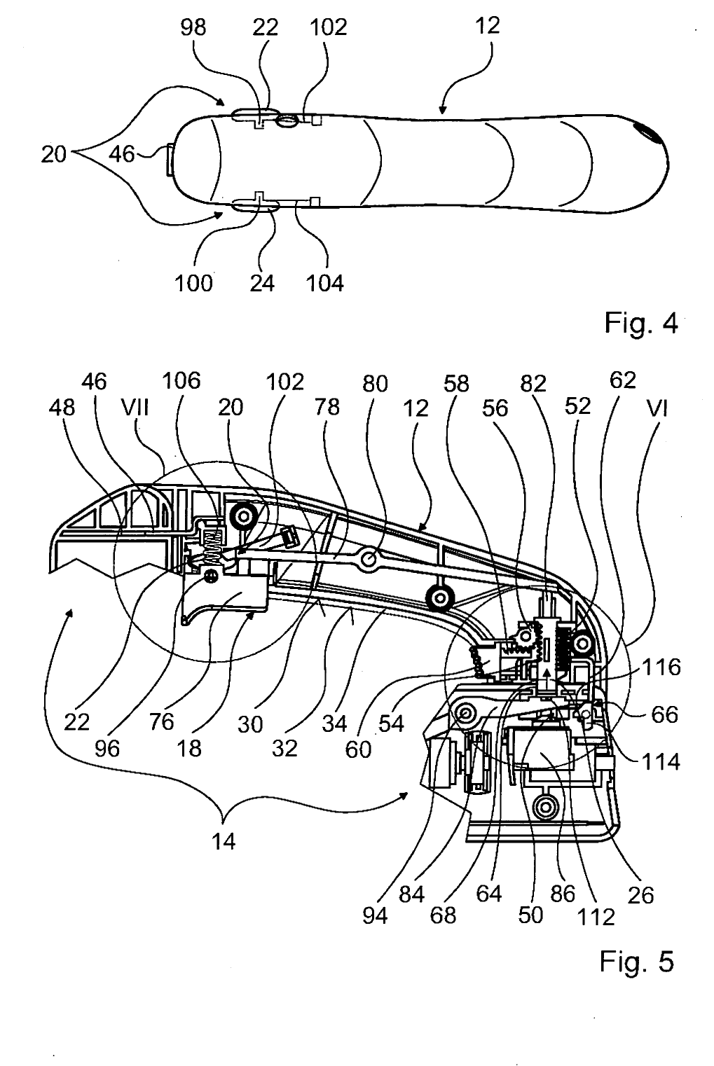

A locking mechanism 20 for locking the on-off switch 18 is also integrated into the top handle 12. The locking mechanism 20 has two decoupled actuating elements 22, 24 comprised of separate components that are situated on opposite sides or side surfaces of the top handle 12 (FIG. 4). On their sides facing into the interior of the top handle 12, each of the actuating elements 22, 24 has a respective pin 98, 100, each of which can be pushed independently of each other, counter to the spring forces of leaf springs 102, 104 acting on the actuating elements 22, 24 and, when the actuating button 76 is in its on position, can be inserted into a through opening 96 of the actuating button 76 to lock the latter in an on position.

If a user releases an actuating force for depressing the actuating button 76 before an actuating force for depressing one of the actuating elements 22, then the pin 98 or 100 of the depressed actuating element 22 or 24 is clamped in the through opening 96 because a spring return force of a helical compression spring 106 loads the actuating button 76 toward its off position and the pin 98 or 100 is subjected to a shearing action and clamped in position between an outer wall of the top handle 12 and the actuating button 76.

If after being locked in position, the actuating button 76 is once again subjected to an actuating force toward its on position, then the spring force of the leaf spring 102 or 104 deflects the actuating element 22 or 24, which has been actuated to engage the locking mechanism, back outward into its starting position and the locking mechanism is disengaged.

According to the present invention, the top handle 12 can also be provided to constitute a support surface 30 for the back of a hand. The top handle 12 in this case advantageously constitutes a specially adapted open reach-through region 108 between the housing 16 and the top handle 12 itself so that when the hand-held power tool is guided by means of the barrel grip 10, the back of a user's hand is also supported against the top handle 12. A distance 110 between the support surface 30 of the top handle 12, which is oriented toward the barrel grip 10 in a middle region in the longitudinal direction of the top handle 12, and a top side of the barrel grip 10 situated directly opposite the support surface 30 in this region would be advantageously designed with regard to a hand thickness of a target user group and preferably would be less than 12 cm and particularly preferably, less than 10 cm.

To achieve a reach-through region 108 that can be easily adapted to a user at least within limits, to assure a connection between the back of the user's hand and a support surface 32 of the top handle 12 by means of an elastic clamping force, and to increase comfort, the support surface 32 can also be constituted by a soft elastic component 34, as depicted in FIGS. 1 and 5. The component 34 can be detachably or non-detachably attached to the top handle 12 by means of various frictionally engaging, form-locking, and/or integrally joined connections deemed suitable by those skilled in the art.

If the top handle 12 is used to constitute a support surface 30 or 32 for the back of a hand, then it should be advantageously possible to activate and deactivate the hand-held power tool by means of the on-off switch 28 integrated into the barrel grip 10. This could possibly be achieved by omitting a locking of the rocker switch 84 by means of the U-shaped retaining tab 62.

What is claimed is:

1. A hand-held power tool, in particular a barrel jigsaw, having a barrel grip (10), characterized by means of a detachable top handle (12) and an attaching device (14) for attaching the top handle (12).

2. The hand-held power tool as recited in claim 1, wherein the fastening device (14) is provided for tool-free attachment and/or detachment of the top handle (12).

3. The hand-held power tool as recited in claim 1, wherein an on-off switch (18) is at least partially integrated into the top handle (12).

4. The hand-held power tool as recited in claim 3, wherein a locking mechanism (20) for locking the on-off switch (18) is integrated into the top handle (12).

5. A hand-held power tool having a handle (12) and an on-off switch (18) at least partially integrated into the handle (12) and having a locking mechanism (20) for locking the on-off switch (18), in particular as recited in claim 4,
wherein the locking mechanism (20) has at least two at least largely decoupled actuating elements (22, 24).

6. The hand-held power tool as recited in claim 5, wherein the actuating elements (22, 24) are situated on opposite sides of the top handle (12).

7. The hand-held power tool as recited in claim 3,
wherein the fastening device (14) is at least partially integrally joined to a functional component of the on-off switch (18).

8. The hand-held power tool as recited in claim 7, wherein a holding mechanism of the fastening device (14) is integrally joined to an actuator rod guide.

9. The hand-held power tool as recited in claim 8, wherein the holding mechanism is comprised of a locking pin (26).

10. The hand-held power tool at least as recited in claim 3, wherein the on-off switch (18) at least partially integrated into the top handle (12) is at least in part integrally joined to an on-off switch (28) at least partially integrated into the barrel grip (10).

11. The hand-held power tool as recited in claim 1,
wherein the top handle (12) is provided to constitute a support surface (30, 32) for the back of a hand.

12. The hand-held power tool as recited in claim 11, wherein the support surface (32) is comprised of a soft elastic component (34).

13. A top handle (12) for a hand-held power tool as recited in claim 1.
